(19) United States
(12) Patent Application Publication
(10) Pub. No.: US 2002/0188421 A1
(43) Pub. Date: Dec. 12, 2002

(54) Method and apparatus for maximum entropy modeling, and method and apparatus for natural language processing using the same

(76) Inventors: Koichi Tanigaki, Tokyo (JP); Yasushi Ishikawa, Tokyo (JP)

Correspondence Address: BIRCH STEWART KOLASCH & BIRCH, PO BOX 747, FALLS CHURCH, VA, 22040-0747, US

(21) Appl. No.: 10/092,557

(22) Filed: Mar. 8, 2002

(30) Foreign Application Priority Data
Apr. 13, 2001 (JP) 2001-115249
Sep. 14, 2001 (JP) 2001-279640

(51) Int. Cl. G06F 15/00; G06F 17/18; G06F 101/14

(52) U.S. Cl. 702/181

(57) ABSTRACT

A maximum entropy modeling method is provided which is capable of selecting valid feature functions by excluding invalid feature functions, reducing a modeling time and realizing a high accuracy. The maximum entropy modeling method includes: a first step (S1) of setting an initial value for a current model; a second step (S2) of setting a set of feature functions as a candidate set; a third step (S3) of comparing observed probabilities of respective feature functions included in the candidate set with estimated probabilities of the feature functions according to a current model, and determining the feature functions to be excluded from the candidate set; a fourth step (S4) of adding the remaining feature functions included in the candidate set after excluding the feature functions to be excluded to the respective sets of feature functions of the current model, and calculating parameters of a maximum entropy model thereby to create a plurality of new approximate models; and a fifth step (S5) of calculating a likelihood of learning data using the approximate models, and replacing the current model with a model that is determined based on the likelihood of learning data.

This application is based on Application No. 2001-279640, filed in Japan on Sep. 14, 2001, the contents of which are hereby incorporated by reference.

### BACKGROUND OF THE INVENTION

1. Field of the Invention

The present invention relates to a method and apparatus for creating a maximum entropy model used for natural language processing in a speech dialogue system, speech translation system and information search system, etc. and a method and apparatus for natural language processing using the same, and more specifically, to a method and apparatus for creating a maximum entropy model and a method and apparatus for natural language processing using the same such as morpheme analysis, dependency analysis, word selection and word order determination in language translation or conversion to commands for an dialogue system or search system.

2. Description of the Related Art

As a conventional maximum entropy modeling method, the method referred to in “A Maximum Entropy Approach to Natural Language Processing” (A. L. Berger, S. A. Della Pietra, V. J. Della Pietra, Computational Linguistics, Vol.22, No.1, p.39 to p.71, 1996) will be explained first.

A maximum entropy model P that gives a conditional probability of output y with respect to input x is given by expression (1) below.

$$P ( y \vert x ) = \frac{1}{Z ( x )} exp ( {\sum }_{i} {λ}_{i} {f}_{i} ( x , y ) ) \qquad ( 1 )$$

However, in expression (1), fᵢ(x, y) is a binary function called “feature function” and takes “1” or “0” depending on the values of input x and output y. λi is a real number value weight corresponding to a feature function fᵢ(x, y). Z(x) is a normalization term to make “1” the value of a total sum expression ΣP(x|y) of the maximum entropy model P with respect to the output y.

Therefore, creating the maximum entropy model P is equivalent to determining a feature function set F(={fᵢ(x, y)|i=1,2, . . . }) used by the maximum entropy model P and a weight Λ(={λi|i=1,2 . . . }) in expression (1).

Here, one of the methods of determining the weight Λ when the feature function set F is given is a conventional algorithm called “iterative scaling method” (see the above document of Berger et al.).

Furthermore, one of the conventional methods of determining the feature function set F(={fᵢ(x, y) |i=1,2, . . . }) used in the maximum entropy model P is as follows.

That is, as a prior art 1, there is a feature selection algorithm referred to the above document of Berger et al.

This is an algorithm that selects the feature function set F( [symbol] Fo) used in the model P from a feature function candidate set Fₒ which is given in advance and is constructed of the following sequential steps.

Step 1: Set F=φ.

Step 2: Obtain a model P(F∪f) by applying the iterative scaling method to each feature function f( [symbol] Fo).

Step 3: Calculate an increment of logarithmic likelihood ΔL(F, f) when each feature function f( [symbol] Fo) is added to the set F and select one feature function fˆ with the largest increment of logarithmic likelihood ΔL(F, f).

Step 4: Add the feature function fˆ to the set F to form a set fˆ ∪F, which is then set as a new set F.

Step 5: Remove the feature function fˆ from the candidate set Fo.

Step 6: If the increment of logarithmic likelihood ΔL(F, f) is equal to or larger than a threshold, return to step 2.

The above steps 1 to 6 make up a basic feature selection algorithm.

However, in step 3, selecting the feature function Fˆ requires the maximum entropy model P(F∪f) to be calculated for all feature functions f, which requires an enormous amount of calculations. For this reason, it is impossible to apply the above algorithm as it is to many problems.

Then, instead of the increment of logarithmic likelihood ΔL(F, f), a value calculated by the following approximate calculation is actually used (seethe above document of Berger et al).

If a parameter of a model P_{F} is assumed to be a weight Λ, a weight α corresponding to the feature function f is newly added to the model P(F∪f) in addition to the weight Λ. Here, suppose the value of weight Λ does not change even if a new feature function f is added to the feature function set F.

Actually, an optimal value of the existing weight is changed by adding a new restriction or parameter, but the above assumption is introduced to efficiently calculate the increment of logarithmic likelihood.

An approximate model for the feature function set F ∪f obtained in this way is represented by P^{α}_{F,f}.

Furthermore, an approximate increment of logarithmic likelihood ˜ΔL(F, f) calculated using the approximate model P^{α}_{F,f} is used instead of the feature selection algorithm, i.e., increment of logarithmic likelihood ΔL(F, f) in step 3 above.

At this time, the iterative scaling method in step 3 above, which has been the optimization problem of n parameters, is approximated by the one-dimensional optimization problem for parameter α corresponding to the feature function f, so the amount of calculations is thereby reduced accordingly.

In summary, the realistic feature selection algorithm according to the above document of Berger et al. is as follows:

Step 1a: Set F=φ.

Step 2a: Obtain an approximate model P^{α}_{F,f} with the parameter for the set F fixed for each feature function f( [symbol] Fo).

Step 3a: Calculate an approximate increment of logarithmic likelihood ˜ΔL(F, f) when each feature function f( [symbol] Fo) is added to the set F, and select one feature function f′ˆ with the largest approximate increment ˜ΔL(F, f).

Step 4a: Add the feature function f′ˆ to the set F to form a set f′ˆ ∪F, which is then set as a new set F.

Step 5a: Remove the feature function F′ˆ from the candidate set Fo.

Step 6a: Find a model P_{F} by using the iterative scaling method.

Step 7a: Calculate the increment of logarithmic likelihood ΔL(F, f) and if this is equal to or larger than a threshold, return to step 2a.

The above steps 1a through 7a are the feature selection algorithm according to the above document of Berger et al. (prior art 1).

Furthermore, as a prior art 2, there is a method using feature lattices (network).

That is, the method referred to in “Feature Lattices for Maximum Entropy Modeling” (A. Mikheev, ACL/COLING 98, p.848 to p.854, 1998).

This is a method of creating a model by generating a network (feature lattice) having nodes corresponding to all feature functions and combinations thereof included in a given candidate set and repeating frequency distribution of learning data and selection of nodes (feature functions) for the nodes.

Without using any iterative scaling method at all, this method allows models to be created faster than the aforementioned prior art 1.

Moreover, the approximate calculation used in the prior art 1 is not used in this case. If the number of feature function candidates is assumed to be M, the number of network nodes is 2^{M}−1 in the worst case.

The above description relates to the prior art 2.

Furthermore, as a prior art 3, there is a method of determining a feature function used for a model according to feature effects.

This method is referred to in “Selection of Features Effective for Parameter Estimation of Probability Model using Maximum Entropy Method” (Kiyoaki Shirai, Kentaro Inui, Takenobu Tokunaga and Hozumi Tanaka, collection of papers in 4th annual conference of Language Processing Institute, p.356 to 359, March 1998).

This method decides whether or not to select a feature function f by comparing learning data, for which a candidate feature function f returns “1”, with learning data, for which any one feature function f among the already selected feature functions F (on the assumption that it is decided by a self-evident principle) returns “1”.

What should be noted about this method is that the criteria for selecting feature functions are based on not more than a one-to-one comparison among feature functions and there is no consideration given to the already selected feature functions and their weights other than the feature function f and its weight.

The above description relates to the prior art 3.

In addition, as a prior art 4, there is a method of determining weights on feature functions using a iterative scaling method after collectively selecting feature functions to be used as a model from candidate feature functions according to the following criteria (A) or (B).

(A) Method of selecting all feature functions whose observation frequency in learning data is equal to or larger than a threshold (for example, see “Morpheme Analysis Based on Maximum Entropy Model and Influence by Dictionary” (Kiyotaka Uchimoto, Satoshi Sekine and Hitoshi Isahara, collection of papers in 6th annual conference of Language Processing Institute, p.384 to 387, March 2000).

(B) Method of selecting all feature functions whose transinformation content is equal to or larger than a threshold (see Japanese Patent Laid-Open No. 2000-250581).

The above description relates to the prior art 4.

Next, the problems of the prior arts 1 to 4 described above will be explained.

First, the problem of the prior art 1 (the above document of Berger et al.) is that it takes considerable time to create a desired model. This is for the following two reasons.

That is, the first reason is as follows:

According to the prior art 1, each repetitive processing determines feature functions to be added to the model P_{F} based on an approximate calculation.

This approximation calculates an increment of logarithmic likelihood ΔL(F, f) when a feature function f is added to the model P_{F} by fixing the weight parameter of the model P_{F} and calculating only the parameter of the feature function f.

However, regarding the fixed parameter, an optimal value may also be different. Especially when the model P_{F} contains at least one feature function similar to the feature function f, the optimal parameter value about these similar feature functions varies a great deal before and after adding the feature function f.

Therefore, the approximation above cannot calculate an increment of logarithmic likelihood ΔL(F, f) correctly for the feature functions f similar to the feature function already contained in the model P_{F}.

Furthermore, if the feature function f is similar to feature functions contained in the model P_{F}, almost no increment of logarithmic likelihood ΔL(F, f) can be expected even if the feature function f is added to the model P_{F}, and therefore the feature function f can be said to be an invalid feature function for the model P_{F}.

However, the prior art 1, which is unable to correctly evaluate an increment of logarithmic likelihood ΔL(F, f), may mistakenly select the above-described invalid feature function and add it to the model.

As a result, the rate of improvement of models with respect to the number of repetitions decreases and requires more repetitions until a model that implements desired accuracy is created.

This is the first reason that modeling by the prior art 1 takes enormous time.

The second reason is as follows:

Since the calculation of an approximate increment of the above logarithmic likelihood ˜ΔL(F, f) requires repetitive calculations based on numerical analyses such as Newton's method, the amount of calculations is not small by any means. The prior art 1 executes this approximate calculation even on the above-described invalid feature functions, which results in an enormous amount of calculation per repetition.

This is the second reason that modeling by the prior art 1 takes enormous time.

The problem of the prior art 2 (Mikheev) is that the target that can be handled by this method is limited to relatively small problems.

That is, according to the method of the prior art 2, as described above, the number of network nodes required for the number of feature function candidates M is 2^{M}−1 in the worst case, which is prone to cause a problem of combination explosion.

As a result, the prior art 2 cannot handle problems that require a large number of feature function candidates M.

On the other hand, the prior art 3 (Shirai et al.) has the following problem:

As described above, the criteria for selecting feature functions of this method are based on not more than a one-to-one comparison among feature functions and ignores the already selected feature functions and their weights other than the above feature function f and its weight.

That is, even if a candidate feature function is equivalent to a case where a plurality of already selected feature functions are used, the method of the prior art 3 does not take this into account.

As a result, it is not possible to select appropriate feature functions, posing a problem of creating models with poor identification capability.

Another problem of the prior art 4 is as follows:

Generally, there are feature functions, which have small frequency and transinformation content, but can serve as an important and sometimes unique clue to explain non-typical events.

However, the prior art 4 discards even such feature functions of that importance, producing a problem that nothing is learned from non-typical events, creating models with poor identification capability.

As shown above, the prior 1 of the conventional maximum entropy modeling method requires an enormous amount of time for modeling, which involves a problem of causing a delay in the development of a system and making impossible natural language processing by a maximum entropy model itself.

Furthermore, the prior art 2 has a problem that the method itself may not be applicable to the target natural language processing.

Moreover, in the case of the prior art 3 and prior art 4 which are higher in processing speed than the prior art 1, if natural language processing is executed using the maximum entropy model created, there is a problem that desired accuracy may not be achieved and the performance of a speech dialogue system or translation system, etc., may be deteriorated.

### SUMMARY OF THE INVENTION

The present invention is intended to solve the problems described above, and has for its object to provide a method and apparatus for maximum entropy modeling and an apparatus and method for natural language processing using the same, capable of shortening the time required for modeling for natural language processing and achieving high accuracy.

Bearing the above object in mind, according to a first aspect of the present invention, there is provided a maximum entropy modeling method comprising: a first step of setting an initial value for a current model; a second step of setting a set of predetermined feature functions as a candidate set; a third step of comparing observed probabilities of the respective feature functions included in the candidate set with estimated probabilities of the feature functions according to the current model, and determining the feature functions to be excluded from the candidate set; a fourth step of adding the remaining feature functions included in the candidate set after excluding the feature functions to be excluded to the respective sets of feature functions of the current model, and calculating parameters of a maximum entropy model thereby to create a plurality of new models; and a fifth step of calculating a likelihood of learning data using the respective models created in the fourth step and replacing the current model with a model that is determined based on the likelihood of learning data; wherein the maximum entropy model is created by repeating processing from the second step to the fifth step.

With this configuration, the maximum entropy modeling method of the present invention is able to provide a maximum entropy model with high accuracy while substantially reducing the time required for modeling.

In a preferred form of the first aspect of the present invention, the third step performs comparisons between the observed probabilities and the estimated probabilities through threshold determination, and a threshold used in the threshold determination is set to a variable value determined as necessary when the second through fifth steps are repeatedly carried out. Thus, it is possible to achieve a maximum entropy model with desired high accuracy in a short time.

In another preferred form of the first aspect of the present invention, the fourth step calculates the parameters by adding the remaining feature functions included in the candidate set after excluding the feature functions to be excluded to the respective sets of feature functions of the current model, calculates only the parameters of the added feature functions, and creates a plurality of approximate models using the thus calculated parameter values of the added feature functions and the same parameter values of the current model for the parameters corresponding to the remaining feature functions of the current model. The fifth step calculates an approximation likelihood of the learning data using the approximate models created in the fourth step, calculates parameters of a maximum entropy model for a set of feature functions of an approximate model that maximizes the approximation likelihood, and creates a new model to replace the current model therewith.

Thus, it is possible to dynamically determine the feature functions to be excluded from candidates based on model updating situations so as to prevent feature functions effective for a model from being discarded. This serves to further improve identification performance and accuracy.

In a further preferred form of the first aspect of the present invention, the learning data includes a collection of data comprising inputs and target outputs of a natural language processor, whereby a maximum entropy model for natural language processing is created.

According to a second aspect of the present invention, there is provided a natural language processing method for carrying out natural language processing using a maximum entropy model for natural language processing created by the maximum entropy modeling method according to the first aspect of the invention.

According to a third aspect of the present invention, there is provided a maximum entropy modeling apparatus comprising: an output category memory storing a list of output codes to be identified; a learning data memory storing learning data used to create a maximum entropy model; a feature function generation section for generating feature function candidates representative of relationships between input code strings and the output codes; a feature function candidate memory storing the feature function candidates used for the maximum entropy model; and a maximum entropy modeling section for creating a desired maximum entropy model through maximum entropy modeling processing while referring to the feature function candidate memory, the learning data memory and the output category memory.

Thus, the maximum entropy modeling apparatus of the present invention is able to reduce the time required for modeling for natural language processing while achieving high accuracy.

In a preferred form of the third aspect of the present invention, the learning data includes a collection of data comprising inputs and target outputs of a natural language processor, and the maximum entropy modeling section creates a maximum entropy model for natural language processing.

According to a fourth aspect of the present invention, there is provided a natural language processor using the maximum entropy modeling apparatus according to the third aspect of the invention, the processor including natural language processing means connected to the maximum entropy modeling section for carrying out natural language processing using the maximum entropy model for natural language processing.

Thus, the natural language processor of the present invention is also able to reduce the time required for natural language processing while providing high accuracy.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a flow chart showing a maximum entropy modeling method according to a first embodiment of the present invention;

FIG. 2 is a block diagram showing the maximum entropy modeling apparatus according to the first embodiment of the present invention;

FIG. 3 is an explanatory view showing examples of utterance intention according to the first embodiment of the present invention;

FIG. 4 is an explanatory view showing part of learning data according to the first embodiment of the present invention;

FIG. 5 is an explanatory view showing feature function candidates according to the first embodiment of the present invention;

FIG. 6 is an explanatory view showing data examples of a maximum entropy model according to the first embodiment of the present invention;

FIGS. 7(a) and 7(b) are explanatory views showing examples of changes in the number of feature functions to be searched and a change in the model accuracy according to the first embodiment of the present invention;

FIG. 8 is a flow chart showing maximum entropy modeling processing according to a second embodiment of the present invention; and

FIG. 9 is an explanatory view showing examples of a change in the number of feature functions to be searched and a change in the model accuracy according to the second embodiment of the present invention.

### DESCRIPTION OF THE PREFERRED EMBODIMENTS

Now, preferred embodiments of the present invention will be described in detail below while referring to the accompanying drawings.

First, an overview of the present invention will be explained.

The present invention is based on the feature selection algorithm of the prior art 1, but includes a detecting means, to be described in detail later, for efficiently detecting, in a search of feature functions to be added to the model P_{F} of this algorithm, feature functions which are invalid when added to the model P_{F}, whereby valid feature functions to be added to the model can be readily searched from a set of candidates with the invalid feature functions being excluded in advance.

The detecting means for detecting the feature functions which are invalid when added to the model P_{F} examines a difference between an observed occurrence probability P˜(f) of a feature function f in the learning data and an estimated occurrence probability P_{F}(f) of the feature function f according to the model P_{F}, and detects the feature function f as an invalid feature function if the difference is sufficiently small. The observed occurrence probability P ˜(f) and the estimated occurrence probability P_{F}(f) are respectively expressed in expressions (2) below.

$$\begin{matrix}\tilde{P} ( f ) ≡ {\sum }_{x , y} \tilde{P} ( x , y ) f ( x , y ) \\ {P}_{F} ( f ) ≡ {\sum }_{x , y} \tilde{P} ( x ) {P}_{F} ( y \vert x ) f ( x , y )\end{matrix} \qquad ( 2 )$$

In expressions (2), the P˜(f) denotes the probability actually observed in the learning data and the P_{F}(f) denotes the probability calculated using the model P_{F}.

Here, whether the difference between the observed occurrence probability P˜(f) and the estimated occurrence probability P_{F}(f) is sufficiently small or not can be determined by examining a reliability CR(f, P_{F}) calculated by expression (3) below using a well-known binomial distribution [b(x; n; p)(=ₙCₓp^{x}(1−P)^{n-x})] when a total number of learning data is N.

$$R ( f , {P}_{F} ) = \{ \begin{matrix}{\sum }_{x = 0}^{N \cdot \tilde{P} ( f )} b ( x ; N ; {P}_{F} ( f ) ) & if \tilde{P} ( f ) < {P}_{F} ( f ) \\ {\sum }_{x = N \cdot \tilde{P} ( f )}^{N} b ( x ; N ; {P}_{F} ( f ) ) & otherwise\end{matrix} \qquad ( 3 )$$

Although in expression (3) above, the reliability R(f, P_{F}) is calculated with respect to the total number of learning data N, it is also possible to calculate the reliability R(f, P_{F}) with respect to the number n of the input x for which the feature function f takes a value “1”, as shown in expression (4) below.

$$R ( f , {P}_{F} ) = \{ \begin{matrix}{\sum }_{x = 0}^{N \cdot \tilde{P} ( f )} b ( x ; n ; p ) & if \tilde{P} ( f ) < {P}_{F} ( f ) \\ {\sum }_{x = N \cdot \tilde{P} ( f )}^{N} b ( x ; n ; p ) & otherwise\end{matrix} \\ n = N \cdot {\sum }_{xs \cdot t \cdot 3 y , f ( x , y ) = 1} \tilde{P} ( x ) \\ p = N \cdot {P}_{F} ( f ) / n \qquad ( 4 )$$

If the reliability R(f, P_{F}) calculated from expression (3) or expression (4) above is equal to or larger than threshold θ, the difference between the observed occurrence probability P˜(f) and the estimated occurrence probability P_{F}(f) can be considered small enough to be ignored.

The following is the reason that the feature function f(f being not included in the set F) whose difference between the observed occurrence probability P˜(f) and the estimated occurrence probability P_{F}(f) is small is regarded as invalid for the model P_{F}.

The maximum entropy model P_{F} is originally given as a probability distribution P that maximizes entropy while satisfying a restriction equivalent expression of expression (5) below with respect to all the feature functions f( [symbol] F) included in the set F (see Berger et al.).

P(f)=\tilde{P}(f) (5)

Therefore, if the model P_{F} already satisfies the restriction equivalent expression indicated by expression (5) above with respect to the feature function f which is not included in the set F, even if a model P(F∪f) obtained by adding that feature function f to the set F is created, it is obvious that the expected effect of improvement in logarithmic likelihood cannot be obtained as compared to the model P_{F}.

The reliability R(f, P_{F}) indicated in expression (3) or expression (4) above is intended to directly judge whether the restriction equivalent expression regarding the feature function f is satisfied or not.

The present invention is characterized in that this invalid feature function f is excluded from the search targets that follow. For this reason, it is possible to reduce the amount of calculations and solve the problem of the time required for modeling.

Furthermore, by forcing the posterior step to select a feature function really effective for the model P_{F} it is possible to create a model with excellent accuracy. Embodiment 1.

One embodiment of the present invention will be now explained below while referring to the accompanying drawings.

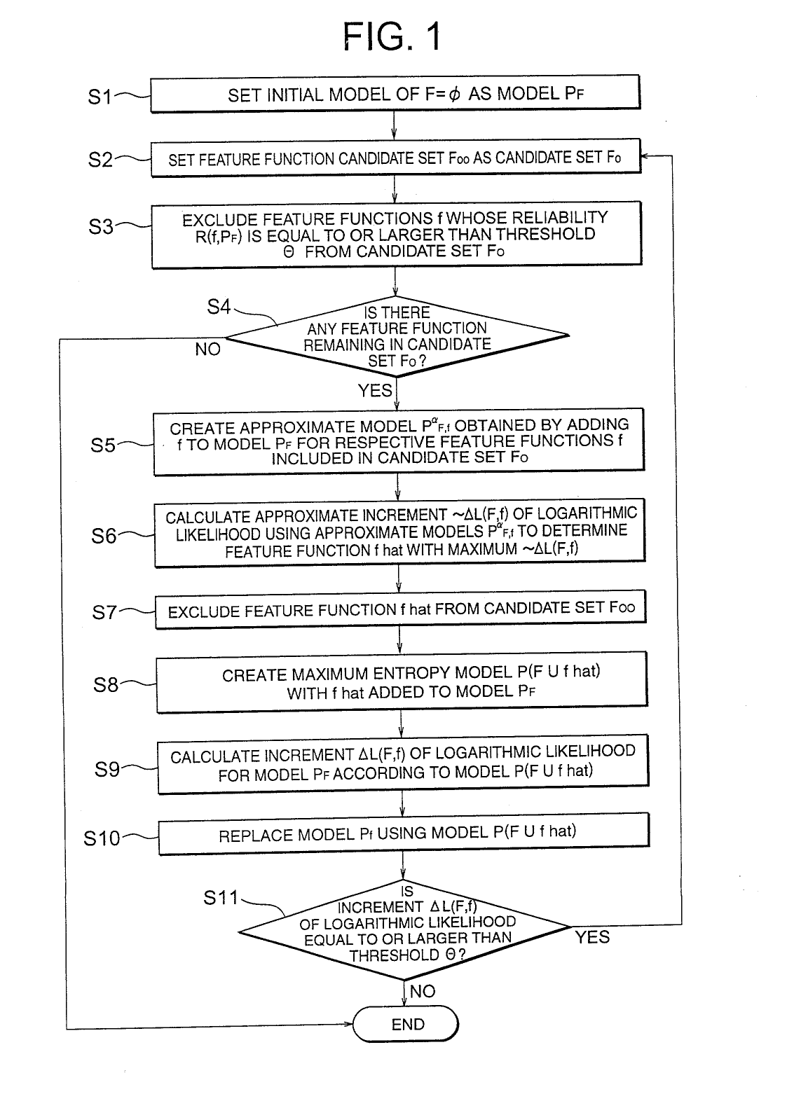

FIG. 1 is a flow chart showing a maximum entropy modeling processing according to the embodiment of the present invention.

Here, this embodiment will be explained assuming that a maximum entropy model using a feature function set F is denoted as P_{F}.

In FIG. 1, in step S1, suppose F=φ, that is, a maximum entropy model with no feature function is first set as an initial model P_{F}.

In step S2, a feature function candidate set F₀₀ given beforehand is set as a candidate set Fo.

In step S3, the reliability R(f, P_{F}) defined in expression (3) or expression (4) above is calculated for each of feature functions f( [symbol] Fo) included in the candidate set Fo.

As a result, a feature function f whose reliability R(f, P_{F}) is equal to or smaller than threshold θ is regarded as an invalid feature function even if added to the model P_{F} and excluded from the candidate set Fo.

In step S4, the number of feature functions remaining in the candidate sect Fₒ is determined, and when it is determined that there is no feature function remaining in the candidate set Fₒ (that is, “NO”), the processing of FIG. 1 is terminated.

On the other hand, when it is determined in step S4 that there is one or more feature function remaining in the candidate set Fₒ (that is, “YES”), the control process goes to the following step S5.

Instep S5, an approximate model P^{α}_{F,f} of a maximum entropy model obtained by adding the feature function f to the set F is created using the feature functions f( [symbol] Fo) included in the candidate set Fo.

Here, parameters of the approximate model P^{α}_{F,f} is calculated using the method (of the prior art 1) that fixes the weight parameter for the set F to the same value as the model P_{F}. In step S6, an approximate increment of logarithmic likelihood ˜ΔL(F, f) corresponding to the model P_{F} is calculated using each approximate model P^{α}_{F,f} created in step S5 from expression (6) below and a feature function fˆ that maximizes this is selected.

˜ΔL(F,f)=L(P^{α}_{F,f})−L(P_{F}) (6)

In step S7, the feature function fˆ is removed from the set Fₒₒ.

In step S8, the maximum entropy model P(F∪fˆ ) obtained by adding the feature function fˆ to the set F is created by using a iterative scaling method.

In step S9, an increment of logarithmic likelihood ΔL(F, fˆ ) corresponding to the model P_{F} is calculated using the model P(F∪fˆ ) obtained by adding the feature function fˆ to the set F from expression (7) below.

ΔL(F,\hat{f})=L(P_{F∪\hat{f}})−L(P_{F}) (7)

In step S10, the model P_{F} is replaced using the model P(F∪fˆ ) calculated from expression (7) above.

In step S11, the increment of logarithmic likelihood ΔL(F, fˆ ) is compared with the threshold Θ, and when it is determined that ΔL(F, fˆ )≧Θ (that is, “YES”), a return is made to step S2 and the above processing is repeated.

Thus, step S2 to step S10 are repeated as long as the increment of logarithmic likelihood ΔL(F, fˆ ) is equal to or larger than threshold Θ.

On the other hand, when it is determined in step S10 that ΔL(F, fˆ )<Θ (that is, “NO”), the processing of FIG. 1 is terminated.

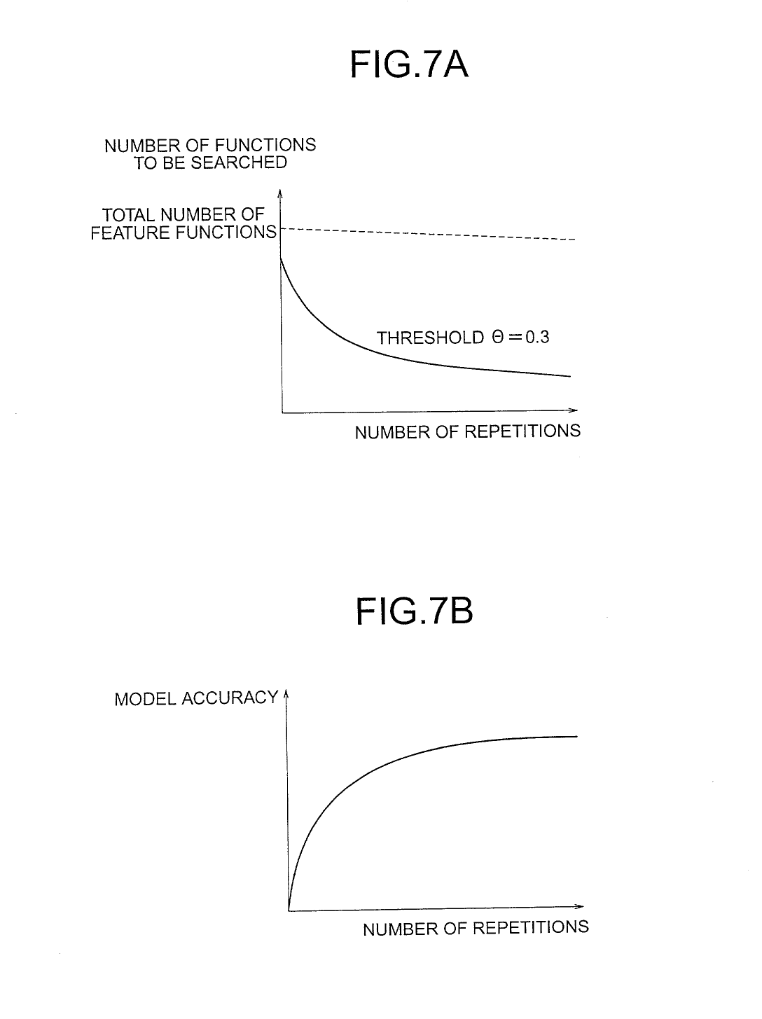

FIGS. 7(a) and 7(b) are explanatory views showing examples of changes in the number of feature functions to be searched and a change in the model accuracy for the above repeated processing according to the first embodiment of the present invention, wherein FIG. 7A shows a change in the number of feature functions to be searched and FIG. 7B shows a change in the model accuracy when the steps S2 through step S10 are repeated.

In FIG. 7A, the solid line represents a change in the number of feature functions according to the present invention, whereas the broken line represents a change in the number of feature functions according to the prior art 1. Here, note that the number of feature functions to be searched means the number of feature functions included in the above candidate set Fo.

As shown in FIG. 7B, by repeatedly adding feature functions to a model, the accuracy of the model gradually increases in accordance with the increasing number of repetitions.

At this time, when the threshold θ is set to 0.3, the number of feature functions to be searched decreases in accordance with the increasing number of repetitions, as shown in FIG. 7B.

For example, according to the method of the aforementioned prior art 1, the feature functions to be excluded from the candidate set Fₒ are only those which are added to the model. Accordingly, the feature functions to be searched are decreased by one upon each repetition, as shown by the broken line in FIG. 7A.

On the other hand, according to the present invention, not only the features functions added to the model but also those feature functions which have the observed occurrence probability thereof close to the estimated occurrence probability of the model are excluded from the candidate set Fo. Of these two kinds of feature functions, those which have the observed occurrence probability thereof close to the estimated occurrence probability of the model increase as the accuracy of the model increases so that the number of feature functions to be searched decreases rapidly in accordance with the increasing number of repetitions, as shown by the solid line in FIG. 7A.

As a result, according to the present invention, it is possible to reduce the number of feature functions to be searched to a substantial extent, thus enabling creation of a model with a desired degree of accuracy in a short period of time.

Here, it is to be noted that though the thresholds has been set to 0.3 by way of example, it may be set to any arbitrary value.

The above is the maximum entropy modeling processing according to the first embodiment of the present invention.

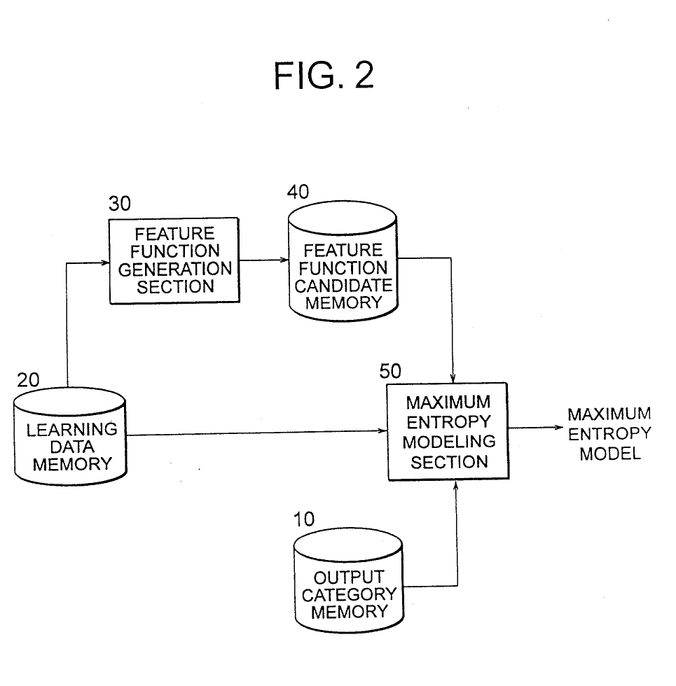

Then, with reference to FIG. 2 to FIG. 6, the processing according to the first embodiment of the present invention will be explained more specifically while taking a case of identifying appropriate intention with respect to a spoken word string as an example.

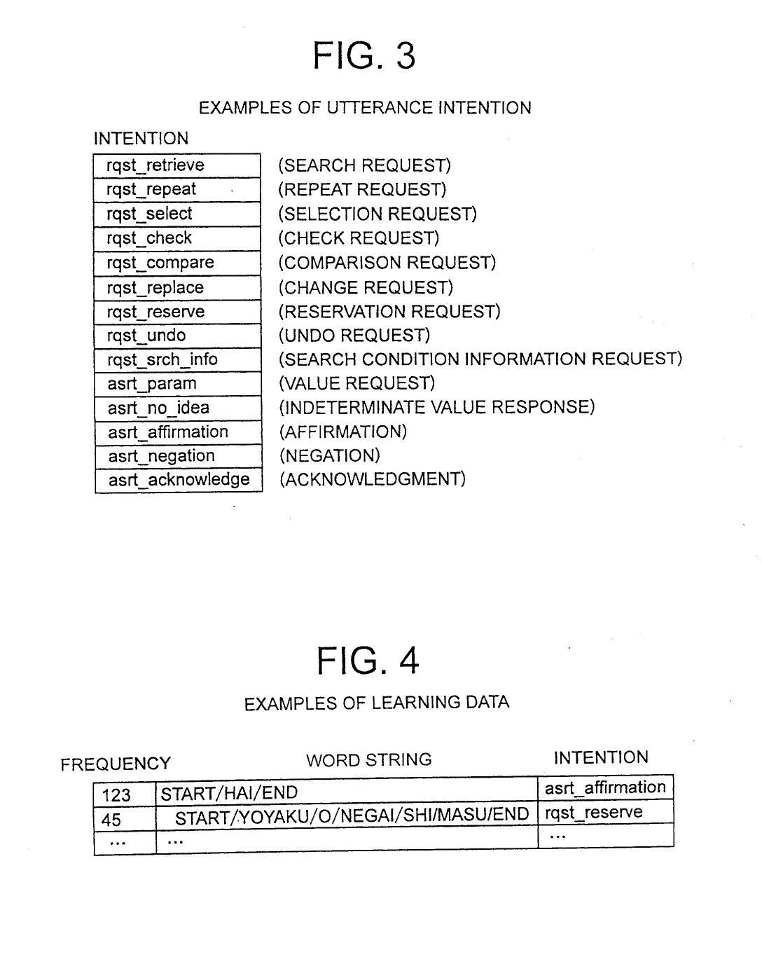

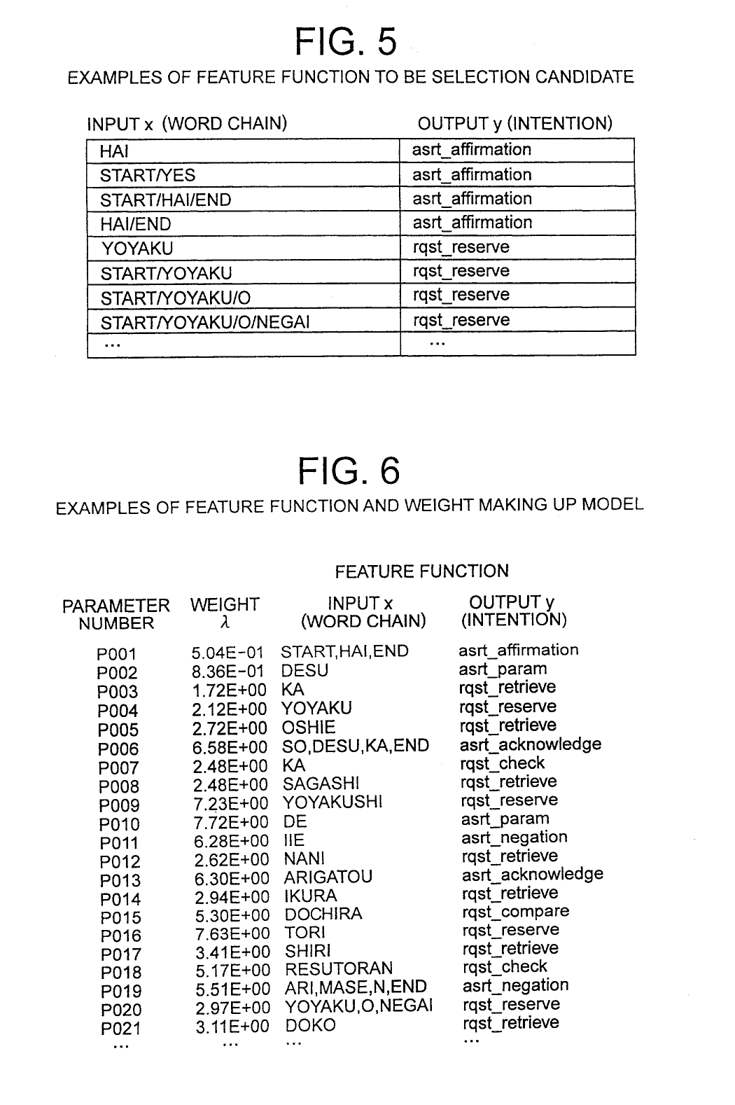

FIG. 2 is a block diagram showing a configuration of a maximum entropy modeling apparatus or processor according to the first embodiment of the present invention. FIG. 3 is an explanatory view showing examples of speech intention. FIG. 4 is an explanatory view showing part of learning data. FIG. 5 is an explanatory view showing feature function candidates. FIG. 6 is an explanatory view showing data of a maximum entropy model.

Now, suppose an utterance morpheme string is W and intention is i. Then, the intention i* to be obtained is given in expression (8) below.

t*=arg max P(i|W) (8)

The conditional probability p(i|W) in expression (8) above is estimated using a maximum entropy model. This maximum entropy model is created using the maximum entropy modeling apparatus or processor shown in FIG. 2.

In FIG. 2, the maximum entropy modeling processor is provided with an output category memory 10, a learning data memory 20, a feature function generation section 30, a feature function candidate memory 40 and a maximum entropy modeling section 50.

Furthermore, a natural language processing means (not shown) is connected to an output section of the maximum entropy modeling section 50 in the natural language processor using the maximum entropy modeling apparatus shown in FIG. 2, and this natural language processing means is intended to carry out natural language processing using a maximum entropy model for natural language processing.

In this case, the learning data memory 20 stores data that collects inputs and target outputs of the natural language processor as learning data.

The output category memory 10 is given a list of intentions to be identified beforehand and stores the list.

At this time, there are 14 types of defined intentions such as “rqst_retrieve”, “rqst_repeat”, etc., as shown in FIG. 3.

A rough meaning of each intention is shown by a comment to the right of each line in FIG. 3 such as (retrieval request), (re-presentation request), etc.

The data memory 20 in FIG. 2 is given learning data to be used to create a maximum entropy model beforehand and stores the learning data.

Part of the learning data is shown in FIG. 4.

Each line in FIG. 4 is data corresponding to an utterance and is constructed of three components; the frequency of occurrences of utterances, word string and intention that will become a target output of the model.

Incidentally, in the word string in FIG. 4, START and END are pseudo-words that indicate the utterance start position and utterance end position, respectively.

The feature function candidate memory 40 in FIG. 2 stores feature function candidates used for the maximum entropy model. These feature function candidates are created by the feature function generation section 30. Suppose that a feature function used indicates a relationship between a word chain and an intention.

By enumerating co-occurrence between word chains and intentions that occur in learning data, feature function candidates are generated as shown in FIG. 5.

Each line in FIG. 5 denotes one feature function.

For example, the second line in FIG. 5 denotes a feature function that takes a value “1” when a word chain “START/hai” occurs in an utterance word string and the intention is “asrt_affirmation”, and takes a value “0” otherwise.

The maximum entropy modeling section 50 in FIG. 2 creates a desired maximum entropy model through the maximum entropy modeling processing in FIG. 1 while referring to the feature function candidate memory 40, learning data memory 20 and output category memory 10.

However, in the maximum entropy modeling processing above, input x corresponds to the word string W and output y corresponds to the intention i.

As a result, data of the maximum entropy model as shown in FIG. 6 is output.

Then, a case of identifying the intention of an utterance will be explained using the maximum entropy model data shown in FIG. 6.

Now suppose “TART/sore/de/yoyaku/o/negai/deki/masu/ka/END” is given as the utterance word string W.

The probability that each intention in FIG. 3 will occur for this word string W will be calculated according to aforementioned expression (1).

For example, when the probability of occurrence of “rqst_reserve” is calculated, it is apparent from FIG. 6 that the feature functions that take a value “1” for the word string W are feature functions “P004” and “P020”.

Using weights “2.12” and “3.97” assigned to these feature functions, the probability of occurrence of “rqst_reserve” for the word string W are calculated as shown in expression (9) below.

$$P ( rqst\_reserve \vert W ) = \frac{1}{Z ( W )} exp ( 2.12 + 2.97 ) \approx \frac{1}{Z ( W )} \times 162.39 \qquad ( 9 )$$

Likewise, the probabilities of occurrence of intentions “rqst_check”, “rqst_retrieve” and “asrt_param” are calculated as shown in expression (10) below.

$$\begin{matrix}P ( rqst\_check \vert W ) = \frac{1}{Z ( W )} exp ( 2.46 ) \approx \frac{1}{Z ( W )} \times 11.7 \\ P ( rqst\_retrive \vert W ) = \frac{1}{Z ( W )} exp ( 1.72 ) \approx \frac{1}{Z ( W )} \times 5.58 \\ P ( rqst\_check \vert W ) = \frac{1}{Z ( W )} exp ( 0.772 ) \approx \frac{1}{Z ( W )} \times 2.16\end{matrix} \qquad ( 10 )$$

In other cases, regarding 10 types of feature functions i, there is no feature function that takes value “1” for the word string W, and therefore the occurrence probability P(i|W) is calculated as shown in expression (11) below.

$$P ( i \vert W ) = \frac{1}{Z ( W )} exp ( 0 ) = \frac{1}{Z ( W )} \times 1 \qquad ( 11 )$$

Then, a normalization coefficient Z(W) is calculated according to expression (12) below, and Z(W)=191.83 is obtained.

$$Z ( W ) = {\sum }_{i} exp ( {\sum }_{j} {λ}_{j} {f}_{j} ( W , i ) ) \qquad ( 12 )$$

Therefore, the occurrence probabilities of intentions for the word string W are:

P(rqst_reserve|W)=0.85

P(rqst_check|W)=0.06

P(rqst_check)=0.01

For other intentions, P(i|W)=0.005.

As a result, by selecting the intention with the highest probability according to expression (9), the intention of the word string W=“START/sore/de/yoyaku/o/negai/deki/masu/ka/END” is identified as “rqst_reserve (reservation request)”.

The maximum entropy modeling method according to the first embodiment excludes invalid feature functions from candidates first, reduces the amount of calculations in this way, expedites the selection of valid feature functions, and can thereby create a model with desired accuracy in a short time.

Furthermore, it is possible to dynamically determine feature functions to be excluded from candidates based on model updating situations, thus minimizing the danger of excluding feature functions effective for a model. As a result, it becomes possible to create models with excellent identification performance.

Therefore, this embodiment can realize a natural language processor with excellent accuracy in a short time.

Although in the aforesaid first embodiment, there has been described the case where the input code string is a word chain and the output code is an intention as an example, it goes without saying that this embodiment will also produce similar effects for other input code strings and output codes. Embodiment 2.

Although in the aforementioned first embodiment, the threshold θ for the reliability R(f, P_{F}) is made constant, it may be varied as required in the course of the maximum entropy model creation processing (during repeated processing).

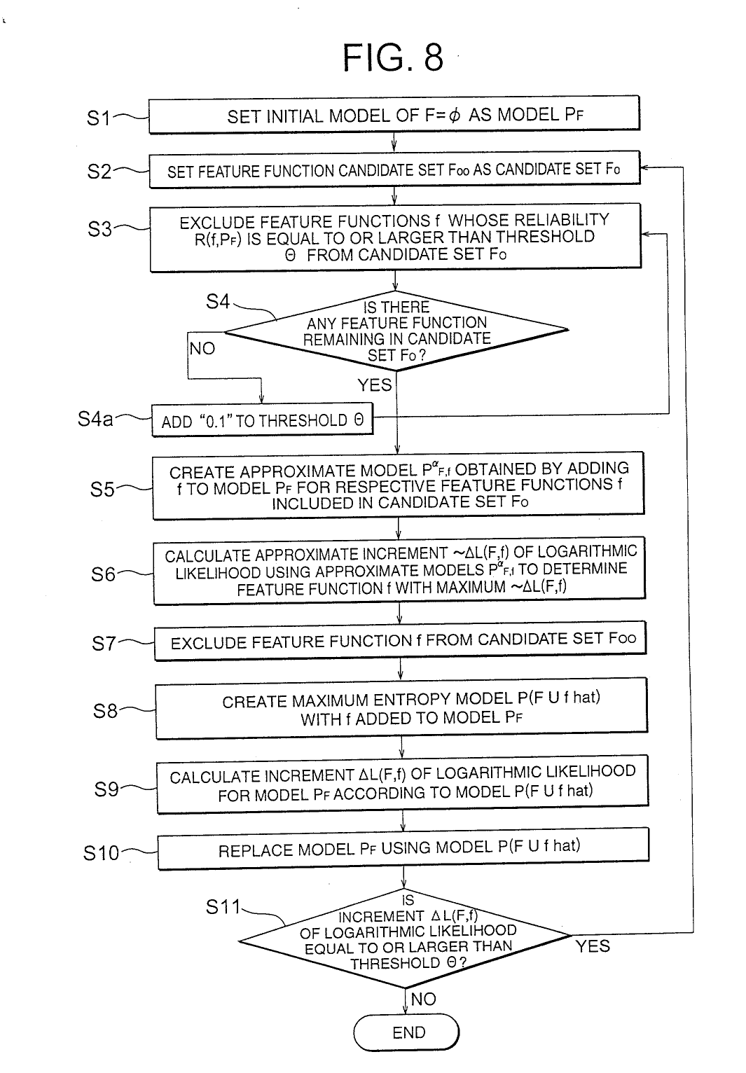

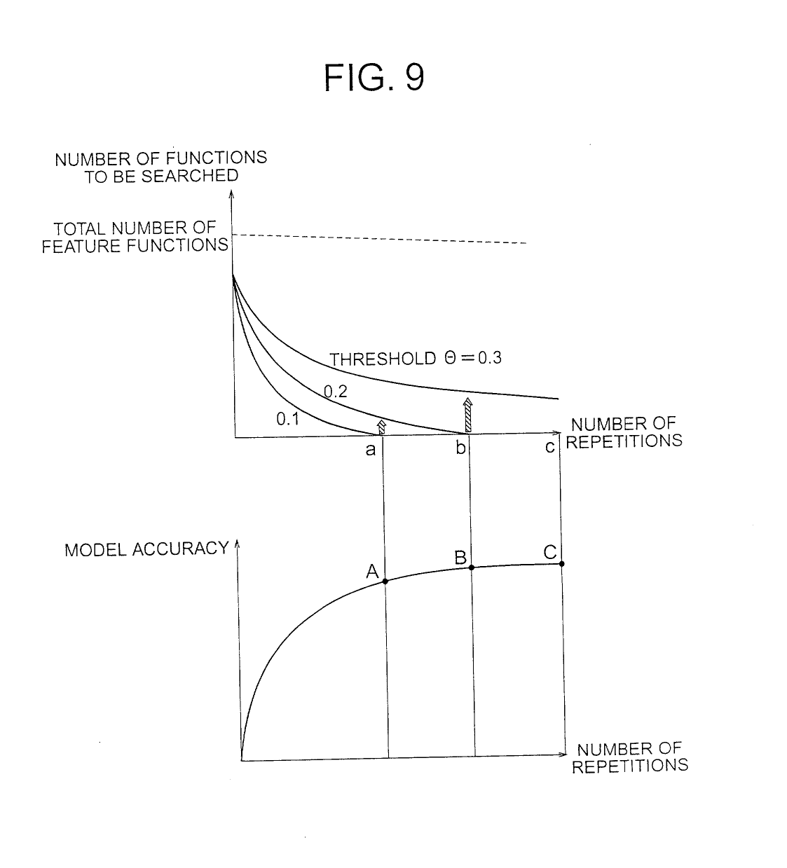

Hereinafter, reference will be made in detail to a second embodiment of the present invention with a variable threshold θ while referring to FIG. 8 and FIG. 9.

In this case, the second embodiment is different from the first embodiment only in the feature that the threshold θ can be varied in the repeated processing during the creation of a maximum entropy model, and hence a description of the portions of this embodiment common to those of the first embodiment is omitted.

FIG. 8 is a flow chart showing one example of the maximum entropy model creation processing according to the second embodiment of the present invention.

In FIG. 8, all the steps other than step 4a are the same as those of the first embodiment (see FIG. 1), and hence they identified with the same symbols while omitting a detailed description thereof.

FIG. 9 is an explanatory view showing a change in the number of feature functions and a change in the model accuracy with respect to the above repeated processing according to the second embodiment of the present invention, and this figure corresponds to FIGS. 7(a) and 7(b).

In FIG. 9, there are shown how the number of feature functions to be searched and the accuracy of the model change when the step S2 to step S10 are repeated under the condition that the threshold θ is fixed to “0.1”, “0.2” and “0.3”, respectively.

When it is determined in step S4 in FIG. 8 that there is no feature function remaining in the candidate set Fₒ (that is, “NO”), step S4a is performed and thereafter a return is made to step S3.

In step S4a, the threshold θ for the reliability R(f, P_{F}) is added by “0.1” and hence changed to a new value (θ+0.1).

Here, when the step S2 to step S10 are repeated with the threshold θ being fixed for example to “0.1”, “0.2” and “0.3”, respectively, the number of feature functions to be searched and the accuracy of the model change as shown in FIG. 9.

That is, when the threshold θ is fixed to “0.3”, as in the preceding case (see FIGS. 7(a) and 7(b)), the accuracy of the model is improved to reach point “C” in FIG. 9 in accordance with the number of repetitions.

On the other hand, when the threshold θ is fixed to “0.1” or “0.2”, the number of feature functions to be searched is less than that when the threshold θ is fixed to “0.3”, and hence the calculation time per the number of repetitions becomes relatively limited in these cases, but all the feature functions are excluded at point “a” or point “b” in FIG. 9, so it becomes impossible to continue learning, as a result of which the accuracy of the model can only reach up to point “A” or point “B”.

Thus, according to the second embodiment of the present invention, learning is carried out by initially using a value “0.1” as the threshold θ, but at the instant when the point a is reached at which the feature functions to be searched are all excluded, the threshold θ is changed from “0.1” to “0.2”, thereby permitting the learning to continue.

Thereafter, at the time when the point “b” is reached at which the feature functions to be searched are all excluded again, the threshold θ is similarly changed from “0.2” to “0.3”, whereby the learning is continued.

That is, learning is continued by changing the threshold θ gradually or in a stepwise fashion as necessary (i.e., each time such a point as “a”, “b” or the like is reached at which the feature functions to be searched are all excluded).

Thus, by widening the threshold θ gradually or stepwise, it is possible to reduce the number of feature functions to be searched as compared with the case in which the threshold θ is fixedly set to “0.3” from the beginning at all times throughout operation. As a consequence, it is possible to create a model capable of achieving the accuracy at point “C” in a short time.

Although the initial value (=0.1) and the incrementally setting value (=0.1) for the threshold θ have been shown herein as examples, it is needless to say that the present invention is not limited to these exemplary values, but any arbitrary values can be employed in accordance with specifications as required.

In this manner, with the maximum entropy modeling method according to the second embodiment of the present invention, it is possible to create a model with desired high accuracy in a shorter time than that required in the maximum entropy modeling method according to the aforementioned first embodiment of the present invention.

Accordingly, a natural language processing apparatus with desired accuracy can be obtained by this second embodiment in a further short time as compared with the case in which the maximum entropy modeling method according to the first embodiment is employed.

While the invention has been described in terms of a preferred embodiment, those skilled in the art will recognize that the invention can be practiced with modifications within the spirit and scope of the appended claims.

What is claimed is:

1. A maximum entropy modeling method comprising:
a first step of setting an initial value for a current model;
a second step of setting a set of predetermined feature functions as a candidate set;
a third step of comparing observed probabilities of said respective feature functions included in said candidate set with estimated probabilities of said feature functions according to said current model, and determining the feature functions to be excluded from said candidate set;
a fourth step of adding the remaining feature functions included in the candidate set after excluding said feature functions to be excluded to the respective sets of feature functions of said current model, and calculating parameters of a maximum entropy model thereby to create a plurality of new models; and
a fifth step of calculating a likelihood of learning data using said respective models created in said fourth step and replacing said current model with a model that is determined based on the likelihood of learning data;
wherein said maximum entropy model is created by repeating processing from said second step to said fifth step.

2. The maximum entropy modeling method according to claim 1, wherein
said third step performs comparisons between said observed probabilities and said estimated probabilities through threshold determination, and
a threshold used in said threshold determination is set to a variable value determined as necessary when said second through fifth steps are repeatedly carried out.

3. The maximum entropy modeling method according to claim 1, wherein
said fourth step calculates said parameters by adding the remaining feature functions included in the candidate set after excluding said feature functions to be excluded to the respective sets of feature functions of said current model, calculates only the parameters of said added feature functions, and creates a plurality of approximate models using the thus calculated parameter values of said added feature functions and the same parameter values of said current model for the parameters corresponding to the remaining feature functions of said current model; and
said fifth step calculates an approximation likelihood of said learning data using said approximate models created in said fourth step, calculates parameters of a maximum entropy model for a set of feature functions of an approximate model that maximizes said approximation likelihood, and creates a new model to replace said current model therewith.

4. The maximum entropy modeling method according to claim 1, wherein said learning data includes a collection of data comprising inputs and target outputs of a natural language processor, whereby a maximum entropy model for natural language processing is created.

5. A natural language processing method for carrying out natural language processing using a maximum entropy model for natural language processing created by said maximum entropy modeling method according to claim 4.

6. A maximum entropy modeling apparatus comprising:
an output category memory storing a list of output codes to be identified;
a learning data memory storing learning data used to create a maximum entropy model;
a feature function generation section for generating feature function candidates representative of relationships between input code strings and said output codes;
a feature function candidate memory storing said feature function candidates used for said maximum entropy model; and
a maximum entropy modeling section for creating a desired maximum entropy model through maximum entropy modeling processing while referring to said feature function candidate memory, said learning data memory and said output category memory.

7. The maximum entropy modeling apparatus according to claim 6, wherein
said learning data includes a collection of data comprising inputs and target outputs of a natural language processor, and
said maximum entropy modeling section creates a maximum entropy model for natural language processing.

8. A natural language processor using said maximum entropy modeling apparatus according to claim 7, said processor including natural language processing means connected to said maximum entropy modeling section for carrying out natural language processing using said maximum entropy model for natural language processing.
